(19) United States
(12) Patent Application Publication
(10) Pub. No.: US 2017/0307190 A1
(43) Pub. Date: Oct. 26, 2017

(54) LUMINAIRES WITH MULTIPLE ILLUMINATION PANELS

(71) Applicant: ABL IP Holding LLC, Decatur, GA (US)

(72) Inventors: Kevin F. Leadford, Evergreen, CO (US); Joshua J. Miller, Highlands Ranch, CO (US); Peter K. Nelson, Denver, CO (US); Carl T. Gould, Golden, CO (US); Christopher D. Slaughter, Denver, CO (US); Christopher J. Sorensen, Denver, CO (US)

(73) Assignee: ABL IP Holding LLC, Decatur, GA (US)

(21) Appl. No.: 15/493,815

(22) Filed: Apr. 21, 2017

Related U.S. Application Data
(60) Provisional application No. 62/325,594, filed on Apr. 21, 2016.
(60) Provisional application No. 62/329,409, filed on Apr. 29, 2016.

(51) Int. Cl. F21V 21/04; F21S 8/04; F21S 8/02

(52) U.S. Cl. CPC F21V 21/048; F21S 8/026; F21S 8/046

(57) ABSTRACT

In one embodiment, a design system based on luminaires having multiple illumination panels includes first and second luminaires. Each of the first luminaires includes three illumination panels arranged in a row. Each of the second luminaires includes five illumination panels of the same size and shape, arranged in an L-shape, with a first, a second and a third panel arranged in a first row, and the third, a fourth and a fifth panel arranged in a second row at a ninety degree angle to the first row. In another embodiment, a design system based on luminaires having multiple illumination panels includes first and second luminaires. Each of the first luminaires includes three illumination panels arranged in a row. Each of the second luminaires includes nine illumination panels of the same size and shape, arranged in a grid of three rows and three columns.

### CROSS-REFERENCE TO RELATED APPLICATIONS

This application is a non-provisional application of, and claims priority to, U.S. Provisional Patent Application Ser. No. 62/355,594, filed 21 Apr. 2016, and 62/329,409, filed 29 Apr. 2016, the entire disclosures of which are incorporated by reference herein in their entireties for all purposes.

### BACKGROUND

Many architectural spaces feature modular ceiling systems, in which hangers are suspended from structural supports, and a gridlike array of ceiling elements (such as tiles and light fixtures) is supported by the hangers. Common modular ceiling systems provide support for 2-by-4 foot or 2-by-2 foot ceiling elements, although other arrangements are possible. Many fluorescent lamp fixtures are based on the standard 2- and 4-foot openings, but opportunities to create visual interest from fluorescent fixtures are limited due to the typical straight-line configuration of fluorescent tubes.

### SUMMARY

Disclosed herein are embodiments that economically provide luminaire lighting design design systems with great flexibility by providing illumination panel arrangements that can be combined in a wide variety of ways. The luminaires can be manufactured with great economy of scale, and can be integrated by the lighting designer of a given installation so as to provide either task or area lighting with design aesthetics that can range from conservative, to playful, to random, or from minimalistic to profuse. The luminaires can be used to establish design features that can be carried over into other portions of an architectural space. Individual illumination panels of the luminaires can project white and/or colored light at a variety of luminous intensities, which can be utilized to provide signature accent colors in an otherwise functional lighting design, for example. The luminaires can be made to integrate easily with modular ceiling grids for easy installation and so as to suggest visual continuity with the ceiling grid.

In an embodiment, a design system based on luminaires having multiple illumination panels includes one or more first luminaires and one or more second luminaires. Each one of the first luminaires includes three illumination panels of a size and a rectilinear shape, arranged in a row. Each one of the second luminaires includes five illumination panels of the same size and rectilinear shape as the illumination panels of the first luminaire, arranged in a five panel L-shape. In the second luminaires, first, second and third ones of the five illumination panels are arranged in a first row, and the third, a fourth and a fifth ones of the five illumination panels are arranged in a second row that is oriented at a ninety degree angle with respect to the first row.

In an embodiment, a design system based on luminaires having multiple illumination panels includes one or more first luminaires and one or more second luminaires. Each one of the first luminaires includes three illumination panels of a size and a rectilinear shape, arranged in a row. Each one of the second luminaires includes nine illumination panels of the same size and rectilinear shape as the illumination panels of the first luminaire, arranged in a grid of three rows and three columns.

### BRIEF DESCRIPTION OF THE DRAWINGS

The present disclosure is described in conjunction with the appended figures:

FIGS. 1, 2, and 3 illustrate a luminaire having nine illumination panels.

FIG. 4 illustrates, in bottom plan view, a luminaire having three illumination panels 110 arranged in a row, in accord with an embodiment.

FIG. 5 illustrates, in bottom plan view, a luminaire having five illumination panels 110 arranged in a horizontal and a vertical row that intersect at a ninety degree angle to form an L-shape, in accord with an embodiment.

FIG. 6 illustrates additional layout options for square ceiling modules in which a nominal size of square illumination panels is one-half the module edge length, or one-fourth of the module area, in accord with an embodiment.

FIG. 7 illustrates some layout options for square ceiling modules in which a nominal size of square illumination panels is one-fourth of the module edge length, in accord with an embodiment.

FIG. 8 illustrates some layout options for square ceiling modules in which a nominal size of square illumination panels is one-fifth of the module edge length, in accord with an embodiment.

FIG. 9 illustrates some layout options for rectangular ceiling modules with a 1:2 aspect ratio in which a nominal size of square illumination panels is one-fourth of the minor module edge length, in accord with an embodiment.

FIG. 10 illustrates some layout options for rectangular ceiling modules with a 1:2 aspect ratio in which rectangular illumination panels are utilized, in accord with an embodiment.

### DETAILED DESCRIPTION

The present disclosure may be understood by reference to the following detailed description taken in conjunction with the drawings described below, wherein like reference numerals are used throughout the several drawings to refer to similar components. It is noted that, for purposes of illustrative clarity, certain elements in the drawings may not be drawn to scale. Specific instances of an item may be referred to by use of a numeral followed by a dash and a second numeral (e.g., illumination panel 110-1) while numerals not followed by a dash refer to any such item (e.g., illumination panels 110). In instances where multiple instances of an item are shown, only some of the instances may be labeled, for clarity of illustration.

Embodiments herein provide new and useful lighting fixtures and methods for modular ceiling systems. Several embodiments are contemplated and will be discussed, but embodiments beyond the present discussion, or intermediate to those discussed herein are within the scope of the present application.

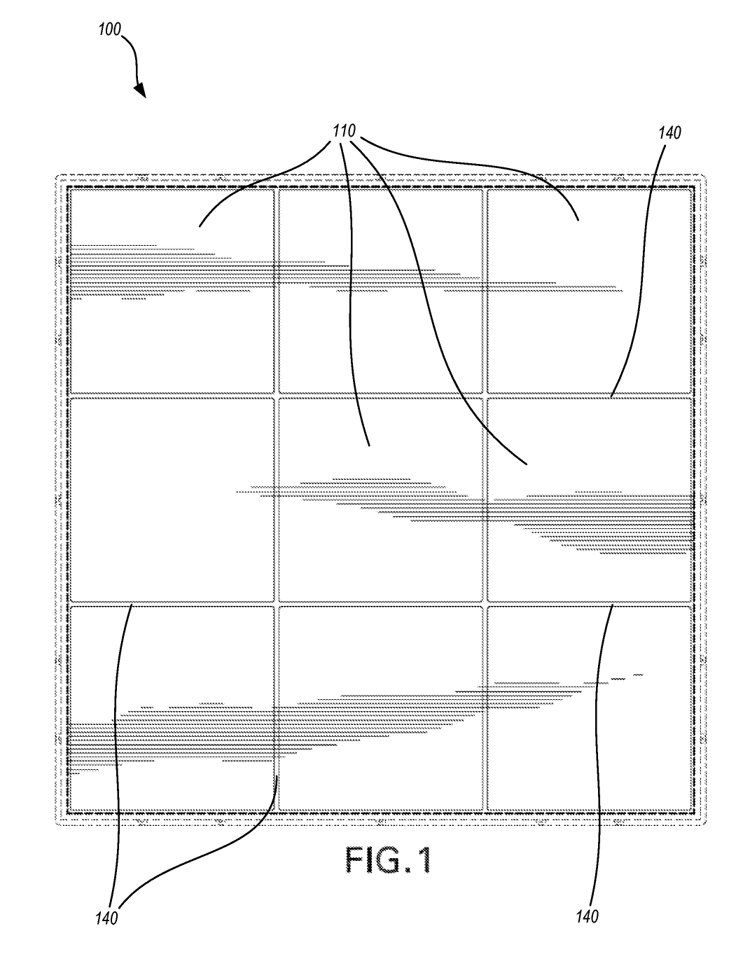

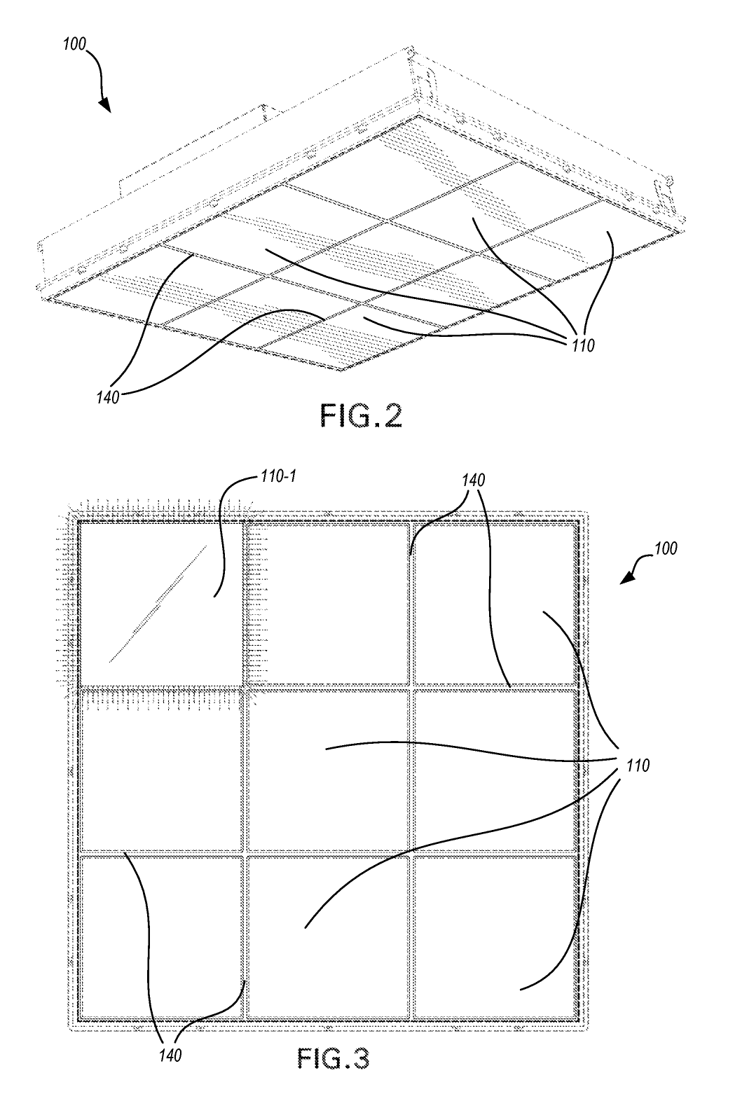

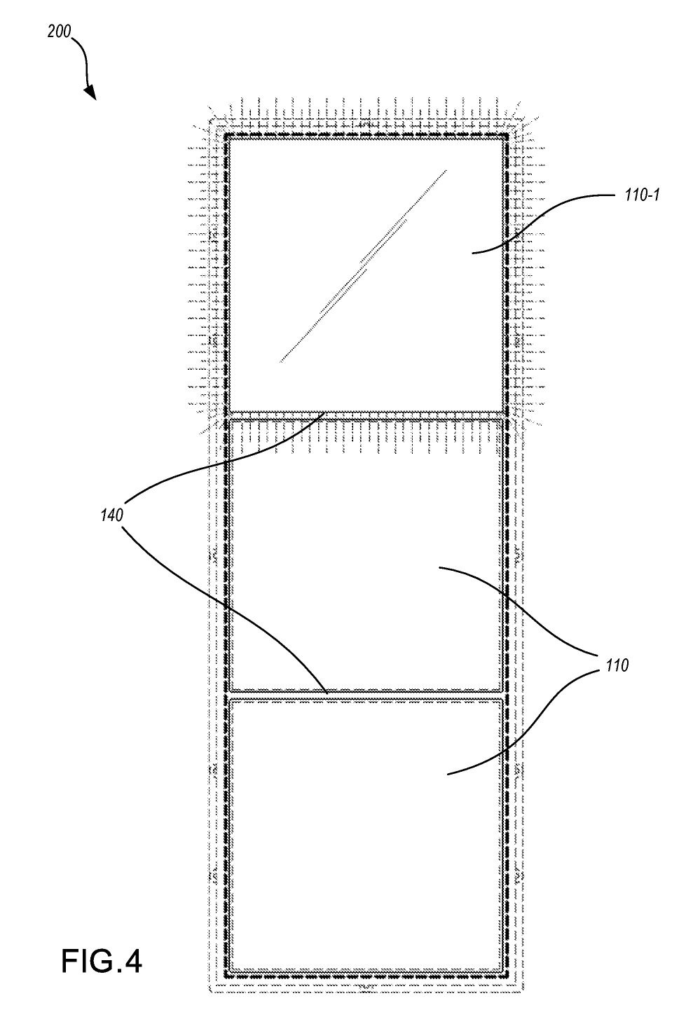

FIGS. 1-5 illustrate components of a design system based on luminaires with multiple illumination panels. FIGS. 1-3 illustrate a luminaire 100 having nine illumination panels 110 arranged in a 3×3 grid, with dividers 140 between adjoining ones of illumination panels 110. FIGS. 1 and 3 are bottom plan views, while FIG. 2 is a perspective view from below. FIG. 4 illustrates, in bottom plan view, a luminaire having three illumination panels 110 arranged in a row, with dividers 140 between adjoining ones of illumination panels 110. FIG. 5 illustrates, in bottom plan view, a luminaire having five illumination panels 110 arranged in a horizontal and a vertical row that intersect at a ninety degree angle to form an L-shape, with dividers 140 between adjoining ones of illumination panels 110. That is, first, second, and third ones of the five illumination panels are arranged in a first row, while the third, a fourth and a fifth ones of the five illumination panels are arranged in a second row that is oriented at a ninety degree angle with respect to the first row. Areas outside the bold broken line in each drawing are typically hidden above support structure after installation.

Luminaires 100, 200 and 300 thus form a set, each member of which is configured to occupy at least part of a similarly sized modular space within a modular ceiling, for example a 2×2 foot square. The set provides visual continuity across such spaces after the luminaires are installed, such that runs of individual panels can be formed across the ceiling to form lighted stripes, squares and other geometric shapes within the ceiling.

Luminaires herein typically provide a plurality of illumination panels per luminaire—such as the nine, three and five illumination panel versions discussed above and shown in FIGS. 1-5—with all physical output surfaces of illumination panels of a luminaire aligned along a single output plane that is common to all of the illumination panels of that luminaire, give or take normal manufacturing tolerances. The single output plane may be formed by output surfaces of independent illumination panels being coupled with structure that aligns the illumination panels, or by providing the illumination panels as lighting components that abut a planar, collective output window or cover, such as disclosed in the disclosures of U.S. Patent Applications No. 61/974,342, filed 2 Apr. 2014; Ser. No. 14/677,618 filed 2 Apr. 2015; and Ser. No. 14/807,398 filed 23 Jul. 2015 (hereinafter, “the Related Applications,” which are incorporated by reference herein).

Embodiments herein generally use light emitting diodes (LEDs) as light sources due to their efficiency, their small size, and the corresponding ease with which they can be configured for uniform luminous intensity (brightness) distribution. However, one skilled in the art would recognize that equivalents and alternatives to the embodiments herein could use any suitable light source or combination of light sources. Illumination panels 110 are configured to provide substantially spatially homogeneous luminous intensity across the area of each panel 110. Advantageously the spatially homogeneous luminous intensity of each illumination panel 110 is within 15%, 10% or 5% across any given area of each panel. This illumination uniformity may be difficult to achieve with light sources such as fluorescent tubes or incandescent bulbs, which tend to have “hot spots” due to hot spots within a light source itself, and/or due to the light source being closer to (or more centered with respect to) certain regions within a panel. However, equivalents that control number and/or spacing of other light source(s) or diffusion characteristics of the outer surface, add further optics, or the like to provide uniform illumination are within the scope of other embodiments herein.

In certain embodiments, illumination panels of luminaires herein are also of uniform luminous intensity across each panel, and are simultaneously Lambertian emitters at each area within a panel. That is, each illumination panel may be not only a Lambertian emitter in an overall sense, but any subdivision of area within such a panel may also be a Lambertian emitter. A Lambertian emitting characteristic is known to be advantageous for some applications in that higher angle output is less intense than output towards nadir (for a horizontally mounted luminaire), such that glare is minimized. This is particularly difficult to achieve with light sources such as fluorescent tubes or incandescent bulbs, which when lit by a single point source (e.g., incandescent) or line source (e.g., fluorescent) tend to provide panels with angular emission characteristics that vary according to distance within a panel from the source, and end-to-center variation within a line source (e.g., dimmer regions near the ends of fluorescent tubes). However, equivalents that control number and/or spacing of the light source(s) or diffusion characteristics of the outer surface, add further optics, or the like to tailor emitting characteristics, are within the scope of other embodiments herein.

Certain embodiments herein also feature closely matched luminous intensity from panel to panel, both within a luminaire and from luminaire to luminaire, and throughout a life span of the luminaire. In embodiments, luminous intensity level is matched across all panels of an installed system to a tolerance of better than 15%, 10% or 5%, over the life span of the luminaire. This is also difficult to achieve with other light sources such as fluorescent tubes or incandescent bulbs, which tend to lose luminous intensity as they age, and which may not age uniformly, such that panels across luminaires or within a luminaire will often present luminous intensity differences that are easily observable to the human eye.

Each of FIGS. 3, 4 and 5 illustrate one panel designated as 110-1 that is illuminated, while other panels 110, shown in broken outline, may or may not be illuminated. The designations of specific panels as illumination panels 110-1 are for illustration only; any ones of the panels 110 may be illuminated at a given time. Apparatus and methods for manipulating color, intensity and/or providing dynamic variation of light provided by illumination panels 110 of the luminaires discussed herein can be readily adapted from the disclosures of the Related Applications.

The design system illustrated in terms of luminaires 100, 200, 300 features an exemplary, small number of luminaire types that install easily within standard modular ceilings (and within certain custom ceilings). Yet, even though this embodiment of the design system only includes three luminaire types, they provide a rich “toolkit” with which designers can create custom lighting designs. Each luminaire type 100, 200, 300 divides a smallest unit of a modular ceiling system into a set of panels 110. This embodiment divides the area of a square ceiling module (e.g., a 2×2 foot or 4×4 foot ceiling tile) into illumination panels that are square and are about ⅓ in length as compared to the module length. But the division of ceiling modules into illumination panels that are about ⅓ of the ceiling module edge length is exemplary only; other embodiments may divide a ceiling module into illumination panels that are about ½, ¼, ⅕, or ⅙, or other fractions, of the module edge length. Furthermore, individual illumination panels and/or luminaires may be shaped as needed to efficiently fill areas of a modular ceiling. That is, although FIGS. 1-5 illustrate cases in which all of the illumination panels of multiple luminaires are of the same size and shape, other sizes and shapes of both illumination panels and luminaires formed from such panels may vary. Because many modular ceilings form rectilinear grids, an important subset of the luminaires described herein includes rectilinear shapes such as squares, rectangles, or composite shapes formed of squares and/or rectangles. Illumination panels of multiple ones of the luminaires will typically be identically sized and shaped as one another, as explained below, but luminaires with multiple shapes and/or sizes of panels are also contemplated.

Given the methodology discussed above, it should be clear that further luminaire types could be added to the design system that includes luminaires 100, 200, 300. Upon reading and comprehending the present disclosure, one of ordinary skill in the art will readily conceive many equivalents, extensions, and alternatives to the specific, disclosed luminaire types, all of which are within the scope of embodiments herein.

The 3×3 panel luminaire illustrated in FIGS. 1-3 fills an entire square ceiling module. The 1×3 panel luminaire (FIG. 4) fills one third of a ceiling module, the remaining two thirds of that module (which may be considered complementary to the area occupied by the 1×3 panel luminaire) would be filled by installing one or more cut-down ceiling tiles. The 5-panel L-shaped luminaire (FIG. 5) fills five-ninths of a ceiling module, the remaining four ninths of that module (complementary to the area occupied by the 5-panel L-shaped luminaire) would also be filled by installing a cut-down tile. Of course these proportions are exemplary only; embodiments that fill a ceiling module with fewer or more illumination panels, or that divide a ceiling module into cells that are smaller or larger portions of the whole module, will accordingly suggest that other portions of the module be filled with cut-down ceiling tiles. Many ceiling tiles are easily cut onsite during construction, so that cut-down tiles could be generated at installation time. Alternatively, a custom filler tile could be offered as part of an installation kit, advantageously packaged with a luminaire that necessitates its use.

In some embodiments, multiple luminaires can be installed adjacent to one another within a ceiling module, while in other embodiments, mechanical features of adjacent luminaires may interfere to the extent that installing adjacent luminaires adjacent to one another within a ceiling module is not practical. In still other embodiments, luminaires that do not fill a ceiling module with illumination panels include one or more custom filler tiles that fill out area of the ceiling module that is not occupied by illumination panels. These embodiments have the advantage that installation can be very simple, as handling and installation of separate pieces of ceiling tile is not needed; every ceiling module is simply filled with a similarly sized luminaire. In yet more embodiments, only luminaires that fill all of the area of a ceiling module with illumination panels are provided.

In some embodiments, individual ones of the illumination panels that are illuminated at a given time are controlled programmatically, as described in the Related Applications. Controls to implement which illumination panels are illuminated may be applied automatically (e.g., by a controller) to an installed set of luminaires each time the set of luminaires is switched on, or may be applied according to input from a user.

Offering a collection of standard luminaires for sale that have identical illumination panel sizes, but a variety of form factors such as shown in FIGS. 1-5, is particularly advantageous. With such a collection available, a designer can exercise a great deal of creativity in lighting various parts of a space. For example, various parts of a space can use such luminaires in different combinations so as to suggest a conservative look, playfulness, a powerful look, minimalism, or even a simple corporate mark such as a logo or icon.

In particular, the 5 panel, L-shaped luminaire 300 can be advantageously used in combination with the 1×3 panel luminaire 200 to generate a wide variety of patterns. The 1×3 panel luminaires 200 can be placed end to end to establish illuminated lines, while the 5 panel L-shaped luminaires 300 can allow such illuminated lines to “turn a corner” in ways that would otherwise not work cleanly. That is, in some arrangements luminaires 200 could not be used to form certain corners, as one of the luminaires 200 would block another at a corner, such that one of the panels would have to cross a support member in the middle of the luminaire. The illuminated lines and other shapes achievable with luminaires 200 and 300 alone can provide a simple but compelling look. The low number of illumination panels in luminaires 200 and 300 advantageously minimize cost for installation where low light levels may be acceptable, while providing a relatively seamless, finished look within a grid ceiling installation.

Addition of the 3×3 panel luminaire 100 to luminaires 200 and 300 allows local ceiling areas to provide more light per unit of ceiling area than luminaires 200 or 300 (e.g., for areas where task lighting is useful), and allows for more options with respect to grayscale and color embodiments, as described further below.

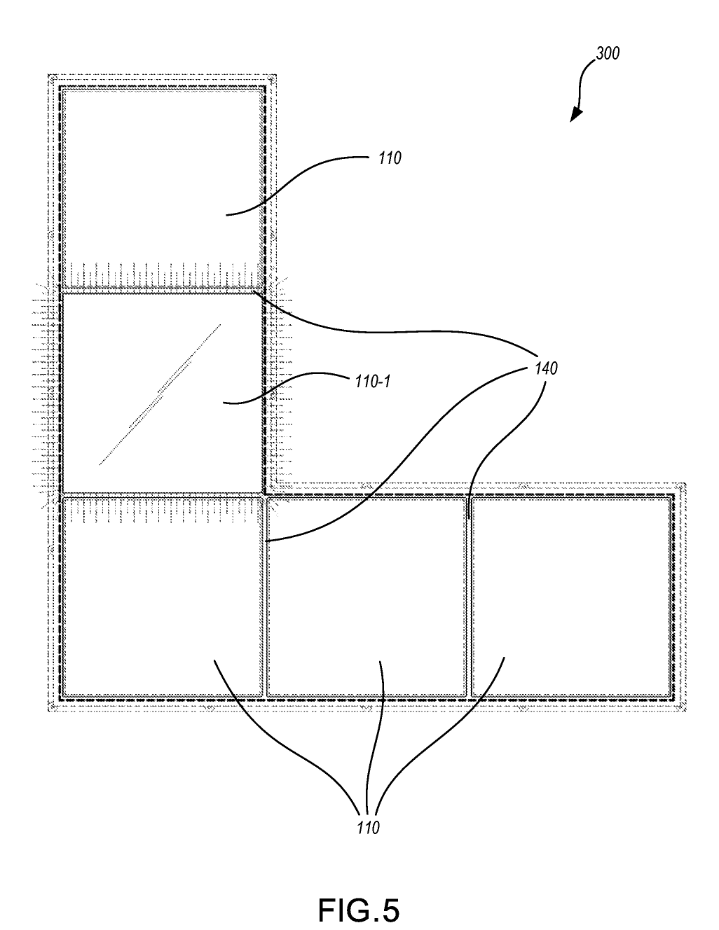

Other embodiments involving different selections of luminaires are also possible. For example, the configurations illustrated in FIGS. 6-10 below are noted as possible, but do not represent every possible configuration of illuminated areas provided by luminaires, and complementary, unilluminated areas, within ceiling grids. It should also be noted that embodiments herein can also correspond with other grid shapes and non-grid ceiling types. One of ordinary skill in the art will recognize many equivalents, extensions, and alternatives.

While modular ceilings are generally laid out on multiples of some physical unit (such as, for example, two feet) embodiments herein may be laid out with center-to-center spacings that exactly correspond to the center-to-center module spacing, or to the center-to-center module spacing less an allowance for support structure at module edges. For example, dividing a two foot module center-to-center spacing by three would result in illumination panels 110 having eight inch center-to-center spacings. Some embodiments may feature exactly that, but may require generous widths of dividers 140 between illumination panels, or custom support structures, to maintain such spacings across adjacent modules. Other embodiments may divide the quantity (module grid spacing minus usual support element width) by the number of elements per module edge, so that the edges of each luminaire can mechanically interface with standard support structure. In these embodiments, illumination panels 110 in adjacent luminaires may be separated by a slightly greater distance than the center-to-center spacing of illumination panels 110 within a luminaire. For this reason, the term “nominal panel size” will be used herein to designate a size of illumination panel 110 that corresponds to a division of a typical modular ceiling spacing by an integer, without allowance for dividers between panels or between adjacent luminaires, although a slightly smaller dimension might actually be used. For example, a luminaire with three panels 110 that are 7.438 inches on a side, separated by two dividers 140 that are 0.188 inch wide, will fill only 22.69 inches of a 24 inch center-to-center spacing, but are considered as having a nominal panel size of 8 inches.

Placement, size and structure of dividers 140 between illumination panels 110 are also recognized as important in achieving an aesthetically “clean” look. In certain embodiments herein, dividers 140 and illumination panels 110 are fabricated so that their physical outer surfaces are flush with one another in the finished luminaire, but this is not a requirement. In these and other embodiments, dividers 140 are advantageously wide enough so that adjacent illumination panels 110 are clearly separated from one another, but narrow enough that they do not consume a great deal of area as compared to illumination panels 110. In the example above with dividers that are 0.188 inch wide and panels that are 7.438 inches wide, the dividers are less than 3% as wide as one side of each illumination panel, and the illumination panels occupy over 95% of the net area of the luminaire. In embodiments intended for installation where ceiling heights are in the range of 8 to 20 feet, dividers 140 are advantageously within the range of 0.125 (one-eighth) inch to 0.25 (one-quarter) inch wide. This width can be scaled up for embodiments intended for installation within higher ceilings, or scaled down for embodiments intended for installation closer to viewers.

In certain embodiments, divider material is advantageously opaque and extends to the flush outer surface. That is, in these embodiments, any transparent or translucent outer covering does not extend across adjacent illumination panels 110, because such coverings tend to act as waveguides, providing light emission from the area of a divider 140 between panels, and optical “bleeding” of light from one panel to another. Other embodiments do include a transparent or translucent covering across adjacent illumination panels; in these embodiments the covering is advantageously thin (e.g., the covering may have a thickness that is less than half the width of dividers 140, or less).

Illumination requirements, room sizes, aesthetics and economy all influence the choice of illumination panel size for a given ceiling. For 2×2 foot or 2×4 foot modular ceiling systems in typical office spaces (e.g., with ceiling heights of about 8 to 20 feet) a nominal panel size of 8 inches provides a good balance of these factors. For larger spaces with higher ceilings and perhaps with 4×4 foot (or larger) ceiling grids, nominal panel sizes of 12 inches or larger may be appropriate. When aesthetics weigh toward detailed patterns and/or when ceiling heights are low, nominal panel sizes of 6, 4.8, 4 or 3 inches may be appropriate. Smaller sizes may lend themselves to creation of more complicated patterns, but may cost comparatively more to manufacture and/or install for a given amount of illumination provided.

In one particular embodiment herein, 3×3, 1×3 and 5 panel L-shaped luminaires that implement a nominal panel size of 8 inches, are particularly suitable for many commercially important ceiling applications. This simple collection of luminaires can be used to serve a wide variety of lighting needs with an equally wide variety of appearances, in a commercially important subset of applications. Thus, such luminaires can be manufactured in high volume, driving cost reduction. Providing such luminaires in pre-packaged kits of multiple luminaires (and, optionally, custom filler tiles to fill out modular ceiling spaces partially filled by ones of the luminaires) can provide further economy of scale. For example, kits of luminaires might include multiples of the 1×3 panel luminaires and the 5 panel, L-shaped luminaires for small installations, more of these luminaires and one or more of the 3×3 panel luminaires for medium sized installations, and larger quantities of all of the luminaires for large installations. Kits with multiples of a single luminaire type would also be possible. These approaches would allow design and construction companies to either design around appropriate kits for best cost savings, or at least purchase some kits for cost savings and individual, additional luminaires for specific luminaires needed to complete a design. Also, as noted above and below, the choice of 3×3, 1×3 and 5 panel L-shaped luminaires is but one particular embodiment; other collections of these and other luminaires are possible.

While embodiments herein are described as having design attributes driven by modular ceiling systems, it is contemplated that these embodiments, and/or scaled versions thereof, are compatible with installations other than modular ceilings. For example, some luminaires 100, 200, 300 may be configured for, and/or actually installed in ceilings of at least part of a structure, while other luminaires 100, 200, 300 may be configured for, and/or actually installed in other portions of the structure such as support beam(s), wall(s), floor(s), surface(s) of built-in and/or suspended structures (e.g., pendant luminaires or other suspended architectural features), and the like, to maintain design continuity across a variety of surfaces for visual interest. The luminaires installed in different portions of a structure need not be of the same size. That is, for example, larger or original scale versions may be installed in ceilings or walls, while smaller or scaled down versions may be installed in surfaces that may be closer to viewers. Embodiments also provide a high degree of areal efficiency, that is, referring to FIGS. 1-5, illumination panels 110 of luminaires 100, 200, 300 emit light over a substantial fraction (e.g., at least 85%, and usually over 95%) of the luminaires' exposed surface area.

Other aspects of embodiments herein may relate to color, grayscale (e.g, luminous intensity of white light) and/or dynamic changes of light provided. In embodiments, selected illumination panels can be illuminated; different illumination panels can be illuminated at different intensities; and intensity and/or chromaticity of light emitted by illumination panels, entire luminaires, and/or a system formed of luminaires can be static or dynamic. That is, which panels are illuminated, and at what intensity, can be programmed to vary, either systematically and/or randomly. Such effects can be manipulated in a variety of ways, depending on the type of light source used in a luminaire and the complexity of controls that can be provided cost effectively, as described in the Related Applications.

Certain embodiments that provide a significant degree of personalization enable a subset of illumination panels 110 (often just one illumination panel 110) of a luminaire herein to emit one or more “signature” color(s), while another subset of the panels emits white light (“white” light itself being considered within a range of shades characterized by color temperature). In these embodiments, the panels that emit color(s) may be referred to as color accent panels. In certain embodiments, fixtures are manufactured with one or more panels equipped with combinations of LEDs and controls that enable customization of the net color emitted by the one or more panels. In some of these embodiments, an end user can operate the controls to establish and/or modify the color emitted by the one or more panels. In others of these embodiments, the controls are available only at installation time, such that a person who installs and/or configures the installation can set the color, but the color is not easily modified thereafter. In yet others of these embodiments, the controls are available only at the factory such that the luminaires arrive pre-configured for a specific color and ready for installation. In further embodiments, luminaires are manufactured with one or more accent panels configured to accept light sources that may be white or may be of a custom color. The luminaires may be manufactured in large quantities until an order is received for a specific color configuration, whereupon light sources (typically LEDs) corresponding to the specific color are installed in one or more specified panel(s) of the luminaires, to provide color accent panels.

Generally, the luminaires described just above are sequentially listed from the more complex and costly, but more flexible (e.g., having variable colors that are controllable after installation by a user) to the less complex and costly, but less flexible (e.g., having factory installed, specific color accent panels). Embodiments within these extremes are contemplated. One skilled in the art will recognize many modifications, alternative constructions, intermediate versions, and equivalents to those that are explicitly described.

When white light of a given luminous intensity is desired across multiple illumination panels and/or luminaires, care may be taken that the chromaticity and luminous intensity of the white light matches across the illumination panels and/or luminaires. Variations in ambient light of up to about +/−5% of total luminous intensity at a given angle and within a 10 step MacAdam ellipse in color are relatively insignificant to a human observer and may be considered “about constant” or “about the same” in the context of far field photometric distributions of embodiments herein. In embodiments, it may be advantageous to limit variations in ambient light to within +/−3% of total luminous intensity at a given angle and within a 5 step MacAdam ellipse in color to limit variations that may be barely visible but possibly distracting.

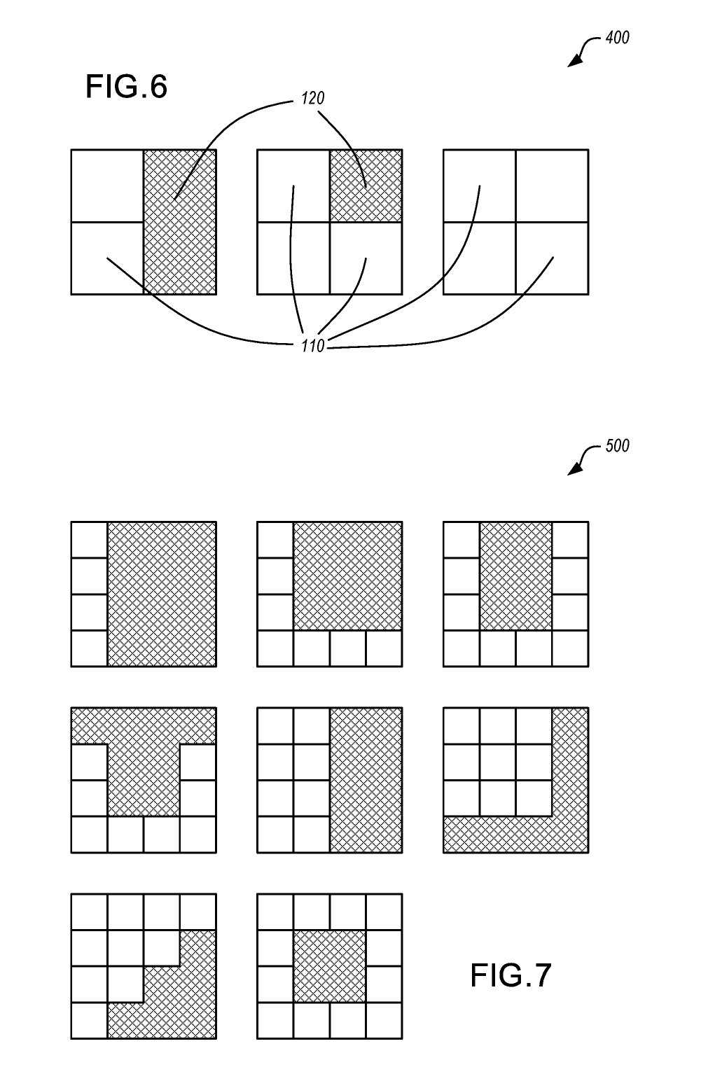

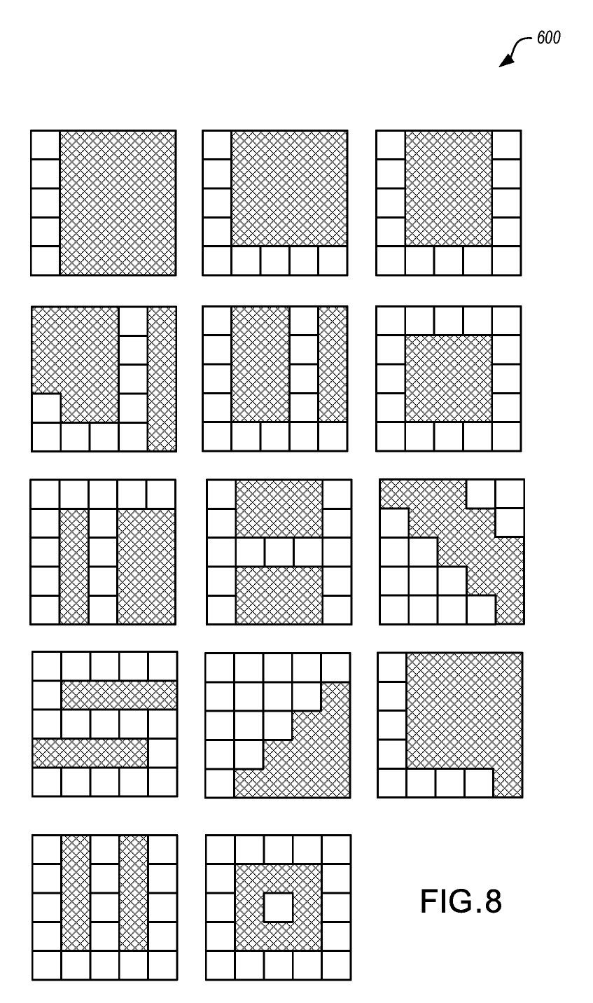

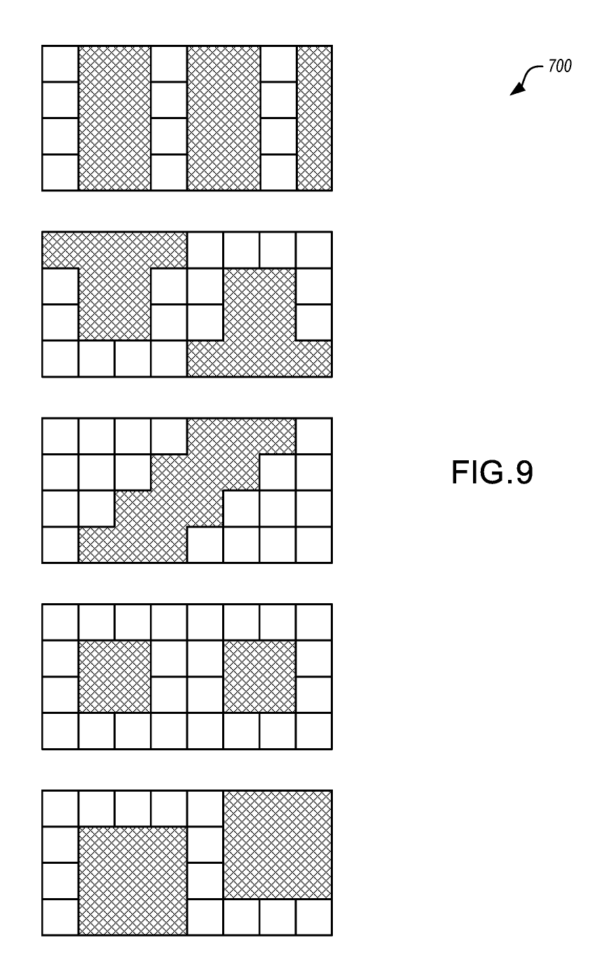

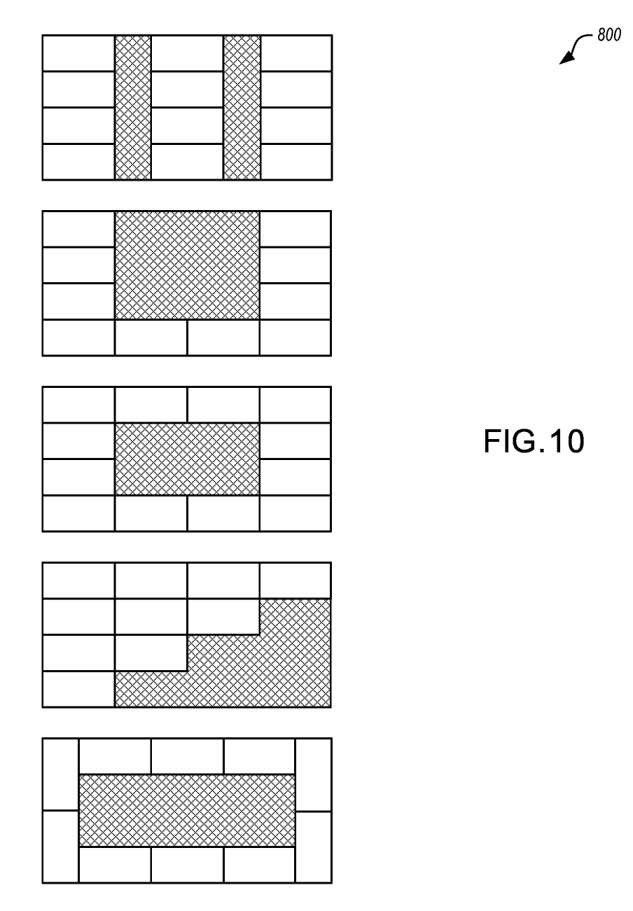

In some embodiments, layout options for luminaires having multiple illumination panels vary greatly, depending on a nominal size of the illumination panels and aspect ratios of the illumination panels and/or ceiling modules for which the luminaires are intended. FIG. 6 shows, in respective bottom plan views, a collection 400 of luminaires illustrating layout options for square ceiling modules in which a nominal size of square illumination panels is one-half the module edge length, or one-fourth of the module area. Unshaded areas illustrate illumination panels 110, as shown, while shaded areas 120 represent complementary areas that may be filled in with cut down or custom fabricated ceiling tiles. The convention of showing luminaires in bottom plan view, illustrating illumination panels 110 using unshaded areas and complementary areas using shaded areas, will be followed in FIGS. 7-10, with reference numerals omitted for clarity of illustration. FIG. 7 shows a collection 500 of luminaires, illustrating some layout options for square ceiling modules in which a nominal size of square illumination panels is one-fourth of the module edge length. FIG. 8 shows a collection 600 of luminaires, illustrating some layout options for square ceiling modules in which a nominal size of square illumination panels is one-fifth of the minor module edge length (that is, the shorter two of the four rectangular edges). FIG. 9 shows a collection 700 of luminaires, illustrating some layout options for rectangular ceiling modules with a 1:2 aspect ratio (e.g., a grid formed of 2 by 4 foot modules) in which a nominal size of square illumination panels is one-fourth of the module edge length. FIG. 10 shows a collection 800 of luminaires, illustrating some layout options for rectangular ceiling modules with a 1:2 aspect ratio, in which rectangular illumination panels are utilized. The illumination panels are not restricted as to being arranged in any particular orientation, as shown. Furthermore, illumination panels that are not rectilinear are also contemplated.

The foregoing is provided for purposes of illustrating, explaining, and describing various embodiments. Having described these embodiments, it will be recognized by those of skill in the art that various modifications, alternative constructions, and equivalents may be used without departing from the spirit of what is disclosed. Different arrangements of the components depicted in the drawings or described above, as well as additional components and steps not shown or described, are possible. Certain features and subcombinations of features disclosed herein are useful and may be employed without reference to other features and subcombinations. Additionally, a number of well-known processes and elements have not been described in order to avoid unnecessarily obscuring the embodiments. Embodiments have been described for illustrative and not restrictive purposes, and alternative embodiments will become apparent to readers of this patent. Accordingly, embodiments are not limited to those described above or depicted in the drawings, and various modifications can be made without departing from the scope of the claims below. Embodiments covered by this patent are defined by the claims below, and not by the brief summary and the detailed description.

What is claimed is:

1. A design system based on luminaires having multiple illumination panels, comprising:
one or more first luminaires and one or more second luminaires, wherein:
each one of the one or more first luminaires comprises three illumination panels of a size and a rectilinear shape, arranged in a row; and
each one of the one or more second luminaires comprises five illumination panels of the same size and rectilinear shape as the illumination panels of the first luminaire, arranged in a five panel L-shape, wherein:
a first, a second and a third one of the five illumination panels are arranged in a first row, and
the third, a fourth and a fifth one of the five illumination panels are arranged in a second row that is oriented at a ninety degree angle with respect to the first row.

2. The design system of claim 1, wherein the rectilinear shape of each of the illumination panels is a square.

3. The design system of claim 1, further comprising one or more third luminaires, wherein:
each one of the one or more third luminaires comprises nine illumination panels of the same size and rectilinear shape as the illumination panels of the first luminaire, arranged in a grid of three rows and three columns.

4. The design system of claim 3, wherein:
the rectilinear shape of each of the illumination panels is a square, each square having a nominal panel size of eight inches; and
edges of each of the first, second and third luminaires are adapted to mechanically interface with standard support structure of a two foot square ceiling grid.

5. The design system of claim 4, further comprising one or more custom filler tiles configured to fill an area that is complementary to an area occupied by the first luminaire or the second luminaire within the two foot square ceiling grid.

6. The design system of claim 1, wherein:
at least two of the illumination panels of each first luminaire, at least four panels of each second luminaire, and at least eight panels of each third luminaire emit white light; and
one illumination panel of at least one of the first, second and third luminaires emits light having a chromaticity other than white.

7. The design system of claim 6, wherein only one illumination panel of each of the first, second and third luminaires emits light having the chromaticity other than white.

8. The design system of claim 6, wherein each of the illumination panels of each of the first, second and third luminaires that emits white light, emits light of a common chromaticity within a five step MacAdam ellipse, and of a single luminous intensity level.

9. The design system of claim 1, wherein:
each of the illumination panels of each of the first, second and third luminaires emits light of a single chromaticity and of a single luminous intensity level.

10. The design system of claim 1, wherein:
each of the illumination panels of each of the first, second and third luminaires emits light of a single chromaticity, and
each of the illumination panels of each of the first, second and third luminaires emits the light with a luminous intensity level that is selected from a predetermined set of luminous intensity levels.

11. The design system of claim 10, wherein the predetermined set of luminous intensity levels includes one of three, four, five or six luminous intensity levels.

12. The design system of claim 1, wherein:
a first subset of the first luminaires, and a first subset of the second luminaires, are of a first scale, and
a second subset of the first luminaires, and a second subset of the second luminaires, are of a second scale that is a scaled down version of the first scale.

13. The design system of claim 1, each of the first and second luminaires further comprising dividers between adjacent ones of the illumination panels, wherein each of the illumination panels has a nominal panel size of eight inches and each divider has a width between 0.125 inch and 0.25 inch.

14. A design system based on luminaires having multiple illumination panels, comprising:
one or more first luminaires and one or more second luminaires, wherein:
each one of the one or more first luminaires comprises three illumination panels of a size and a rectilinear shape, arranged in a row; and
each one of the one or more second luminaires comprises nine illumination panels of the same size and rectilinear shape as the illumination panels of the first luminaire, arranged in a grid of three rows and three columns.

15. The design system of claim 14, wherein:
at least one of the first and second luminaires defines an output plane, and
physical output surfaces of each of the illumination panels are aligned to the output plane of the at least one luminaire.

16. The design system of claim 15, wherein:
the at least one of the first and second luminaires further comprises dividers between adjacent ones of the illumination panels, and
each of the dividers extends to the output plane, separating the illumination panels at the output plane.
